(19) United States
(12) Patent Application Publication
(10) Pub. No.: US 2024/0425264 A1
(43) Pub. Date: Dec. 26, 2024

(54) CONVERTIBLE DECOY BAG AND HUNTING BLIND

(71) Applicant: John Curtis SPAULDING, Villa Ridge, IL (US)

(72) Inventor: John Curtis SPAULDING, Villa Ridge, IL (US)

(21) Appl. No.: 18/753,773

(22) Filed: Jun. 25, 2024

Related U.S. Application Data
(60) Provisional application No. 63/510,252, filed on Jun. 26, 2023.

(51) Int. Cl. B65D 81/36; A01M 31/02; B65D 30/00; B65D 33/25; B65D 33/28

(52) U.S. Cl. CPC B65D 81/365; A01M 31/025; B65D 29/00; B65D 33/2508; B65D 33/28

(57) ABSTRACT

A convertible bag includes a fabric panel, a first pocket and a second pocket affixed to the fabric panel, and one or more zippers for the fabric panel. The first and second pockets configured to receive a respective ground stake. The fabric panel includes a first side edge, a second side edge, a first transverse edge, and a second transverse edge. In a zipped position, the zipper(s) couple the first side edge to the second side edge and couple a first portion of the second transverse edge to a second portion of the second transverse edge, such that the fabric panel forms a decoy bag. In the unzipped position, the fabric panel forms a hunting blind. A method of operating a convertible bag includes converting the convertible bag from a decoy bag into a hunting blind using zipper(s).

### FIELD

This disclosure relates to a bags and blinds used in hunting. More specifically, this disclosure relates to decoy bags used for transporting bird decoys and hunting blinds used during fowl hunting.

### BACKGROUND

A hunter may utilize an assortment of gear to hunt fowl. Typically, a hunter will travel off-road (e.g., by foot, using an ATV, etc.) to their desired hunting area. A decoy is a fake bird used to imitate a specific breed of fowl (e.g., turkey, duck, pheasant, etc.). A group of decoys can be setup to imitate a flock and help attract the desired fowl to the hunting area. A hunting blind can be set up at a desired hunting area to help hide the hunter from fowl until they are within range to shoot. The hunter carries their hunting gear, including decoys, gun/bow, hunting blind, bird calls, etc., with them to a desired hunting area.

### SUMMARY

Embodiments described herein include a convertible bag that can be converted between a decoy bag and a hunting blind. Embodiments described herein include a method of operating said convertible bag between a decoy bag and a hunting blind. The convertible bag can be used as a decoy bag for transporting decoys to a desired hunting location and then as a hunting blind at the hunting location. The convertible bag can advantageously help reduce the weight/items carried/transported by a hunter while traveling to a desired hunting location.

In an embodiment, a convertible bag includes a fabric panel, a first pocket affixed to the fabric panel, a second pocket affixed to the fabric panel, and ones or more zippers for the fabric panel. The fabric panel includes a first side edge, a second side edge opposite the first side edge, a first transverse edge and a second transverse edge each extending between the first side edge and the second side edge. The first pocket is configured to receive a first ground stake. The second pocket is configured to receive a second ground stake. The one or more zippers include a first zipper portion and a second zipper portion. In the zipped position, the first zipper portion couples the first side edge to the second side edge to form a sidewall and the second zipper portion couples a first portion of the second transverse edge to a second portion of the second transverse edge to form a closed end, such that the fabric panel forms a decoy bag. In the unzipped position, the fabric panel forms a hunting blind.

In an embodiment, a method is directed to operating a convertible bag. The convertible bag includes a fabric panel, a first pocket affixed to the fabric panel for receiving a first ground stake, a second pocket affixed to the fabric panel for receiving a second ground stake, and one or more zippers. The fabric panel includes a first side edge, a second side edge opposite the first side edge, and a first transverse edge and a second transverse edge each extending between the first side edge and the second side edge. The one or more zippers include a first zipper portion and a second zipper portion. The method includes converting the convertible bag from a decoy bag into a hunting blind that includes moving the one or more zippers from a zipped position to an unzipped position. In the zipped position, the first zipper portion couples the first side edge to the second side edge to form a sidewall, and the second zipper portion couples a first portion of the second transverse edge to a second portion of the second transverse edge to form a closed end, such that the fabric panel forms the decoy bag. The moving of the zipper from the zipped position to the unzipped position includes uncoupling the first side edge from the second side edge and uncoupling the first portion of the second transverse edge to a second portion of the second transverse edge, such that the fabric panel forms the hunting blind.

### DRAWINGS

FIG. 1 is front view of an embodiment of a convertible bag in a decoy bag configuration.

FIG. 2 is a front perspective view the convertible bag in FIG. 1 in a hunting blind configuration, according to an embodiment.

FIG. 3 is a top perspective view of the convertible bag when open, according to an embodiment.

FIG. 4 is a front view of an embodiment of ground stakes for a convertible bag.

FIG. 5 is a front perspective view of the convertible bag in FIG. 2 including the ground stakes of FIG. 4, according to an embodiment.

FIG. 6 is a rear perspective view of the convertible bag in FIG. 2, according to an embodiment.

FIG. 7 is front perspective view of a convertible bag as employed in the hunting blind configured by a hunter, according to an embodiment.

FIG. 8 is a block flow diagram of an embodiment of a method of operating a convertible bag.

Like numbers represent like features.

### DETAILED DESCRIPTION

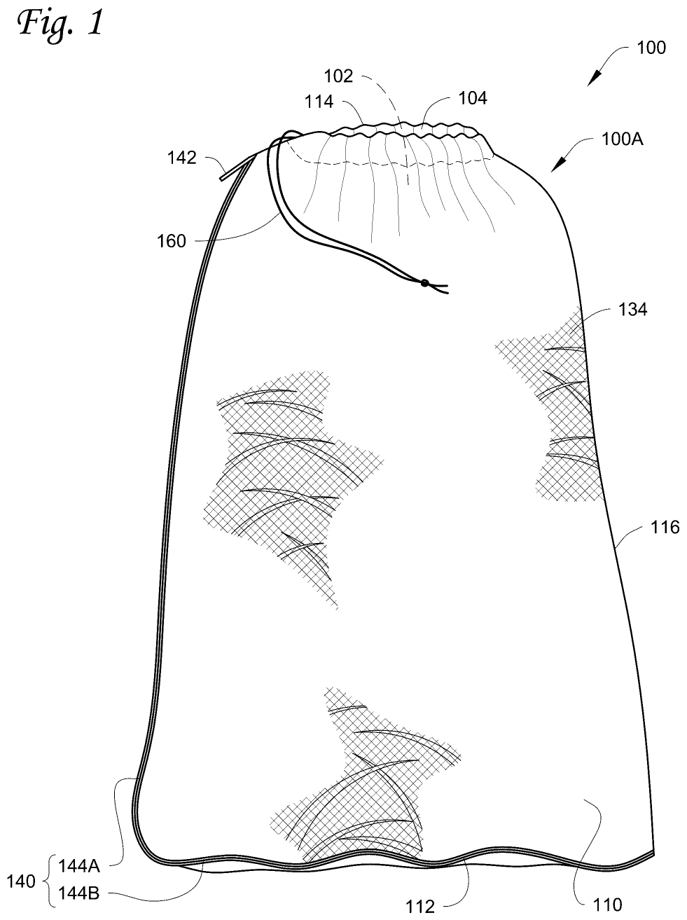

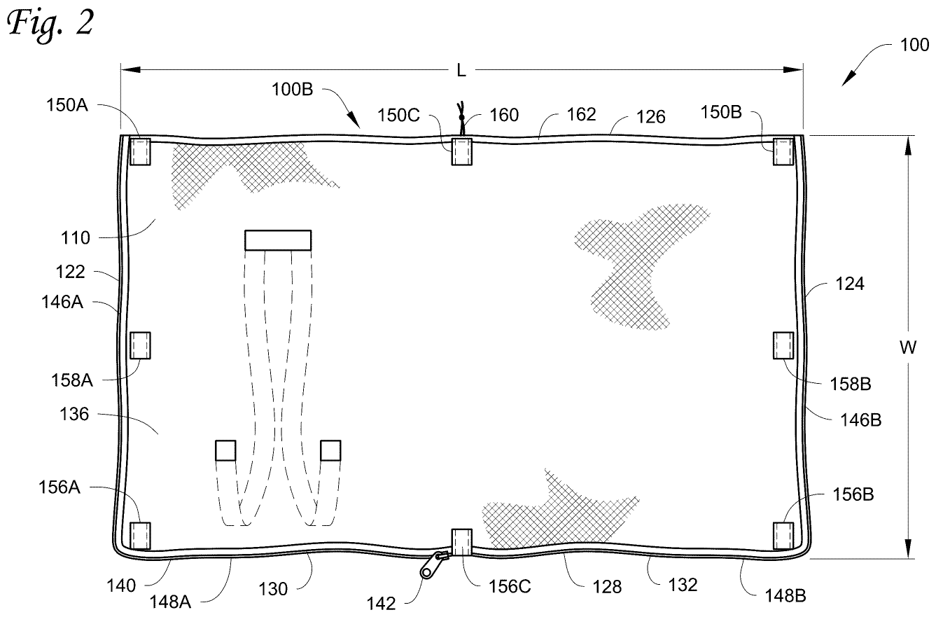

FIG. 1 shows a front view an embodiment of convertible bag 100. The convertible bag in FIG. 1 is in a decoy bag configuration. FIG. 2 shows a front view of the convertible bag 100 converted into a hunting blind, according to an embodiment. The convertible bag 100 is converted into a decoy bag in FIG. 1. The convertible bag 100 is convertible between a decoy bag (as shown in FIG. 1) and a hunting blind (as shown in FIG. 2). The convertible bag 100 when converted into a decoy bag (e.g., as shown in FIG. 1) is referred to herein as “decoy bag 100A” and as being in a decoy bag configuration. The convertible bag 100 when converted into the hunting blind (e.g., as shown in FIG. 2) is referred to herein as “hunting blind 100B” and as being in a hunting blind configuration.

The convertible bag 100 includes a fabric panel 110 that is adjustable to convert the bag 100 between the decoy bag 100A and the hunting blind 100B. The fabric panel 110 is converted/formed into a bag shape in the decoy bag 100A and is converted/formed into a hunting blind shape in the hunting blind 100B. In the decoy bag configuration as shown in FIG. 1, the fabric panel 110 is formed into the bag shape that includes an internal space 102 for storing and transporting hunting decoys (not shown) (e.g., hunting fowl decoys, and the like). For example, the fabric panel 110 in the decoy bag 100A is formed to include a closed end 112, a (closeable) open end 114, and a sidewall 116 (e.g., tubular sidewall) that extends between the closed end 112 and the open end 114. The closed end 112, the open end 114, and the sidewall 116 formed by the fabric panel 110 define the internal space 102.

As shown in FIG. 2, in the hunting blind configuration, the fabric panel 110 has a hunting blind shape that is a substantially planar shape. The substantially planar shaped fabric panel 110 is configured to be anchored to the ground to hide a hunter during hunting. In an embodiment, the hunting blind 100B is a ground blind that can be used to hide a hunter while hunting fowl. The substantially planar fabric panel 110 may be anchored to ground in a desired shape (e.g., planar, concave, curved, angled, etc.) to hide the hunter. The fabric panel 110 has a size sufficient to hide a hunter as the hunting blind 100B. The fabric panel 110 has a width w (e.g., height of the decoy bag 100A, height of the hunting blind 100B) and a length L. As shown in FIG. 2, the length L can extend perpendicular from the width w. In an embodiment, the width w of the fabric panel 110 has a width w of at least 2 feet and a length L of at least 3 feet. Use of the hunting blind 100B is discussed in more detail below.

As shown in FIG. 2, the fabric panel 110 can have a quadrilateral shape. The fabric panel 110 includes a first side edge 122 and a second side edge 124. The first side edge 122 and the second side edge 124 are opposite to each other (e.g., along length L of the fabric panel 110). For example, the first side edge 122 and the second side edge 124 are edges of opposing ends of the fabric panel 110. The first side edge 122 and the second side edge 124 may alternatively be referred to as the left and right edges of the fabric panel 110. The first side edge 122 and the second side edge 124 may define the width w of fabric panel 110 (e.g., height of the decoy bag 100A, height of the hunting blind 100B).

The fabric panel 110 also includes a first transverse edge 126 and a second transverse edge 128. The first transverse edge 126 and the second transverse edge 128 are opposite to each other (e.g., along the width w). For example, the first side edge 122 and the second side edge 124 are edges of opposing sides of the fabric panel 110. The first transverse edge 126 may be referred to as a first end edge, the upper edge, or an open end edge of the fabric panel 110. The second transverse edge 128 may be referred to as a second end edge, a lower edge, or a closed end edge of the fabric panel 110. For example, in the hunting blind 100B, the second transverse edge 128 is configured to be placed on or near the ground. Each of the first transverse edge 126 and the second transverse edge 128 extends between the first side edge 122 and the second side edge 124 (e.g., extends from the first side edge 122 to the second side edge 124).

The convertible bag 100 includes a zipper 140 used to convert the convertible bag 100 between being the decoy bag 100A and the hunting blind 100B (between its decoy bag configuration and its hunting blind configuration). The zipper 140 can be a zipper mechanism as commonly known and employed in the art. For example, the zipper 140 includes a slider 142 that is configured to interlock pairs of teeth together.

The zipper 140 has a zipped position (e.g., as shown in FIG. 1) and an unzipped position (e.g., as shown in FIG. 2). The zipper 140 is moved (e.g., by a hunter) between its zipped position and its unzipped position. The moving of the zipper 140 from the zipped position to the unzipped position is referred to as “zipping”, while the moving of the zipper 140 from the zipped position to the unzipped position is referred to as “unzipping”. Zipping of the zipper 140 converts the convertible bag 100 from a hunting blind 100B into a decoy bag 100A. Unzipping of the zipper 140 converts the convertible bag 100 from a decoy bag 100A into a hunting blind 100B.

When zipped, the zipper 140 couples the first side edge 122 to the second side edge 124 and couples a first portion 130 of the second transverse edge 128 to a second portion 132 of the second transverse edge 128. This results in the fabric panel 110 being formed into a bag shape. The first transverse edge 126 forms the opening 104 of the decoy bag 100A, and the coupled first and second portions 130, 132 of the second transverse edge 128 form the closed end 112 of the decoy bag 100A. The coupled first side edge 122 and second side edge 124 form the sidewall 116 of the decoy bag 100A that extends between the closed end 112 and the open end 114 of the decoy bag 100A. As shown in FIG. 1, the slider 142 of the zipper 140 can be disposed at the open end 114 of the decoy bag 100A (e.g., at the first transverse edge 126).

As shown in FIG. 2, the first side edge 122 may include a first set of teeth 146A and the second side edge 124 may include a second set of teeth 146B. The first side edge 122 is coupled to the second side edge 124 by the zipper 140 interlocking the teeth 146A of the first side edge 122 with the teeth 146B of the second side edge 124.

The second transverse edge 128 includes the first portion 130 and the second portion 132. The first portion 130 and the second portion 132 are different lengths of the second transverse edge 128 (e.g., each forming a different length of the second transverse edge 128). For example, the first portion 130 is disposed closer to the first side edge 122 than the second portion 132 (e.g., closer to the first side edge 122 than to the second side edge 124). For example, the second portion 132 is disposed closer to the second side edge 124 than the first portion 130 (e.g., closer to the second side edge 124 than to the first side edge 122). The first portion 130 can include a first set of teeth 148A and the second portion 132 can include a second set of teeth 148B. The first portion 130 of the second transverse edge 128 is coupled to the second portion 132 of the second transverse edge 128 by the zipper 140 interlocking the teeth 148A of the first portion 130 with the teeth 148B of the second portion 132.

As shown in FIG. 1, the zipper 140 can includes a first zipper portion 144A and a second zipper portion 144B. When zipped, the first side edge 122 is coupled to the second side edge 124 by the first zipper portion 144A of the zipper 140. When zipped, the first portion 130 of the second transverse edge 128 is coupled to the second portion 132 of the second transverse edge 128 by the second zipper portion 144B of the zipper 140. As shown in FIG. 2, the first zipper portion 144A and the second zipper portion 144B are adjacent are on adjust to each other.

When unzipped, the first side edge 122 is uncoupled from the second side edge 124 and the first portion 130 of the second transverse edge 128 is uncoupled from the second portion 132 of the second transverse edge 128 (e.g., the second transverse edge 128 is no longer coupled to itself). This uncoupling converts the convertible bag 100 from the decoy bag 100A into a hunting blind 100B.

In an embodiment, the convertible bag 100 may include multiple zippers for converting the convert the convertible bag 100 between its decoy bag configuration and its hunting blind configuration. For example, the convertible bag 100 may include a first zipper for the first zipper portion 144A and a second zipper for the second zipper portion 144B.

The decoy bag 100A includes an opening 104 for accessing the internal space 102 of the decoy bag 100A. The opening 104 is the opening of the open end 114 of the decoy bag 100A. The opening 104 is used for placing the hunting decoys (not shown) into the decoy bag 100A and for removing the hunting decoys from the decoy bag 100A. The opening 104 in the decoy bag 100A is configured to closeable (e.g., the opening 104 has an open position and a closed position).

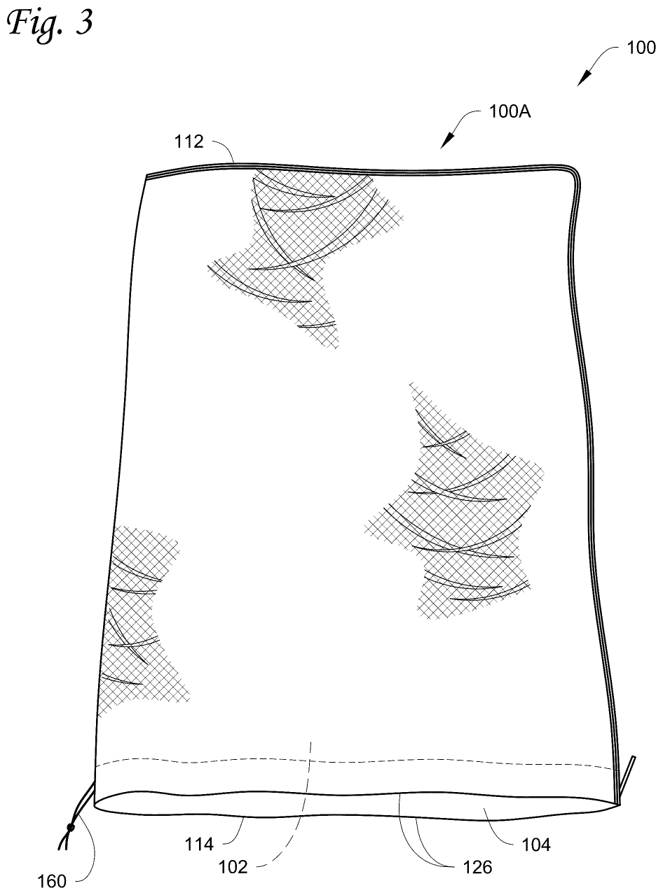

FIG. 2 shows the decoy bag 100A when closed (e.g., opening 104 in the closed position). FIG. 3 shows a top perspective view of the decoy bag 100A when open (e.g., opening 104 in the open positon). In the decoy bag 100A, the adjustment of the length L of the first transverse edge 126 opens and closes the opening 104. For example, the first transverse edge 126 is shortened to close the opening 104 (e.g., to be in a closed position) and is lengthened to open the opening 104 (e.g., to be in an open positon). In the hunting blind 100B, the length L of the first transverse edge 126 can be at its maximum length (e.g., length L is adjusted to be at the maximum length).

As shown in FIG. 2, the convertible bag 100 includes a drawstring 160 configured to adjust the length L of the first transverse edge 126. The drawstring 160 extends through a channel 162 in the fabric panel 110 that extends between the first side edge 122 and the second side edge 124. The channel 162 can be formed in the first transverse edge 126 (e.g., by hemming, or the like). The pulling of the drawstring 160 from the channel 162 (e.g., from the fabric panel 110) shortens the length L of the first transverse edge 126. In the hunting blind 100B, a maximum length of the drawstring 160 is withdrawn into the channel 162. In the decoy bag 100A when closed, a minimum length of the drawstring 160 is withdrawn from the channel 162. In another embodiment, the convertible bag 100 may include a zipper to close the opening 104 in the decoy bag 100A. In such an embodiment, the zipper may be one of the one or more zippers 140 used to convert the convertible bag 100 or a different zipper.

The fabric panel 110 is formed of a flexible fabric material. The flexible fabric material may be made of one or more of a polymer, a textile, or the like. The composition of the flexible fabric material is not particularly limited. For example, the flexible fabric material can be one that provides tear-resistance and durability for use during hunting. The fabric panel 110 may be a mesh panel, a solid panel, or a combination thereof. In the illustrated embodiment, the fabric panel 110 is a mesh panel. It should be appreciated that some of the figures (e.g., FIGS. 1-3, 5 and 6) only explicitly show portions of the fabric panel 110 as mesh for illustrative/clarity purposes. The mesh panel is formed from a mesh material. The mesh size (i.e., the size of the holes in the mesh material) of the mesh material is sufficiently small to allow for covering a hunter disposed behind the hunting blind 100B. For example, the mesh size can be adequately small for the fabric panel 110 to provide camouflage when fowl gets near the hunter. For example, the mesh size can be sufficiently large to allow the hunter/user to see through the fabric panel 110 (e.g., to spot fowl through the mesh). For example, the mesh size can be sufficiently large to allow air to flow through the mesh panel, such that wind puts less stress on the hunting blind 100B when being used.

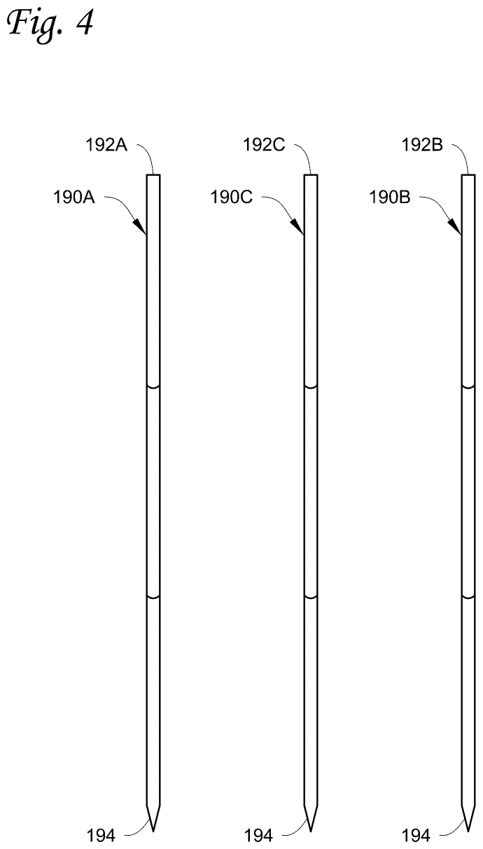

FIG. 4 is a front view of ground stakes 190A, 190B, 190C for the convertible bag 100, according to an embodiment. The convertible bag 100 can include the ground stakes 190A, 190B, 190C for anchoring the hunting blind 100B to the ground (e.g., in an upright position). The ground stakes 190A, 190B, 190C each have a lower end 194 configured to be inserted into the ground. In the hunting blind configuration 100B, the fabric panel 110 is configured to be mounted onto the ground stakes 190A, 190B, 190C. For example, the convertible bag 100 in the hunting blind configuration 100B is configured to be mounted to the ground stakes 190A, 190B, 190C such that the fabric panel 110 extends at or about parallel to the ground.

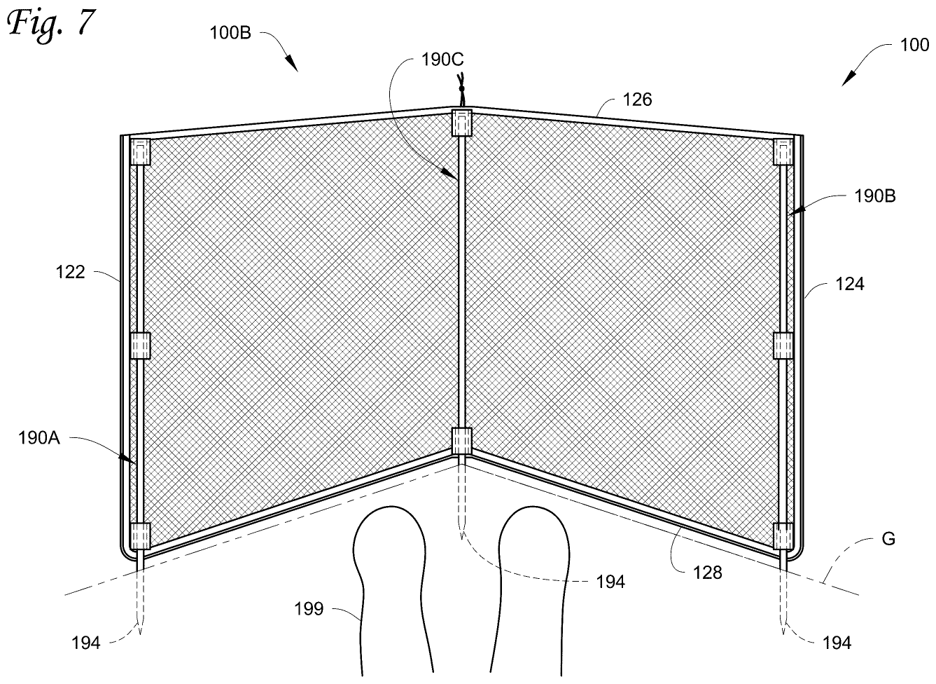

In an embodiment, the ground stakes 190A, 190B, 190C may be expandable (e.g., telescoping or the like) to allow for easier transportation. For example, the expandable ground stakes 190A, 190B, 190C may be collapsed and stored within the decoy bag 100A while a hunter (e.g., user 199 in FIG. 7) travels to a hunting site. The hunter can convert the convertible bag 100 from the decoy bag 100A to the hunting blind 100B at the hunting site, and utilize the expanded ground stakes 190A, 190B, 190C to anchor the hunting blind 100B to the ground at the hunting site. In another embodiment, the ground stakes 190A, 190B, 190B may be carried separately and/or attached to the outside of the decoy bag 100A. The stakes 190A, 190B, 190C can be configured to have a rigid shape during use (e.g., when expanded).

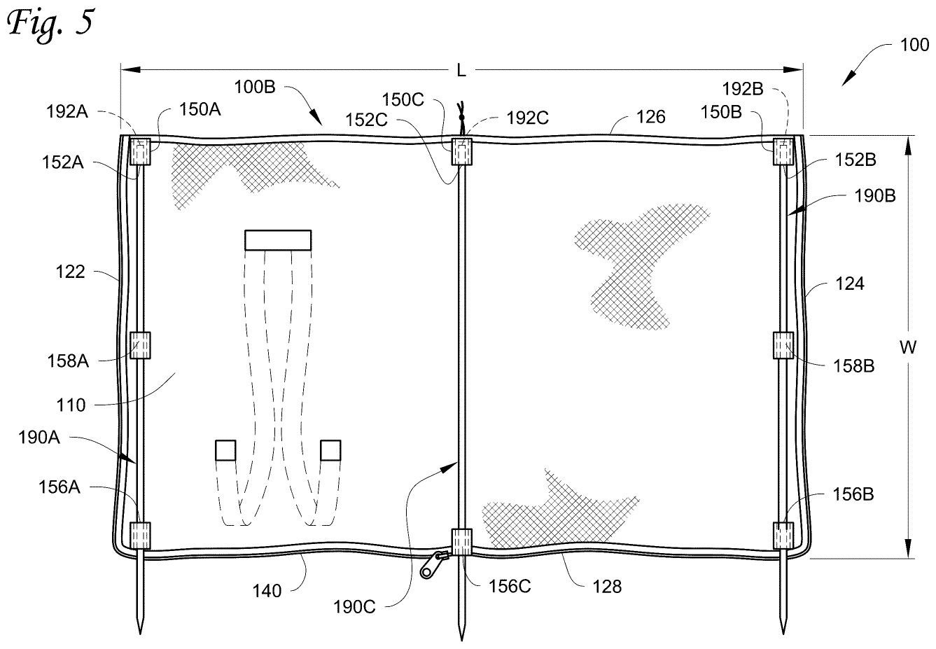

FIG. 5 shows a rear view of the hunting blind 100B with the fabric panel 110 mounted to the stakes 190A, 190B, 190C, according to an embodiment. As shown in FIGS. 2 and 4, the convertible bag 100 includes pockets 150A, 150B, 150B configured to receive the ground stakes 190A, 190B, 190C. Obscured portions of the ground stakes 190A, 190B, 190C are shown in dashed lines in FIG. 5.

The pockets 150A, 150B, 150C are each affixed to the fabric panel 110. A first pocket 150A is affixed to the fabric panel 110 along the first side edge 122 (e.g., closer to the first side edge 122 than to the second side edge 124, at or less than 25% of the total length L from the first side edge 122). A second pocket 150B is affixed to the fabric panel 110 along the second side edge 124 (e.g., closer to the second side edge 124 than to the first side edge 122, at or less than 25% of the total length L from the second side edge 124). A third pocket 150C is affixed to the fabric panel 110 between the first pocket 150A and the second pocket 150B (e.g., along the length L).

The first pocket 150A is configured to receive a first ground stake 190A. For example, the first pocket 150A is configured to receive an end 192A of the first ground stake 190A. The end 192A of the first ground stake 190A is inserted into the first pocket 150A through the opening 152A. The first pocket 150A has an opening 152A that faces the second transverse edge 128. Along the fabric panel 110, the opening 152A faces towards the second transverse edge 128.

The second pocket 150B is configured to receive a second ground stake 190B. For example, the second pocket 150B is configured to receive an end 192B of the second ground stake 190B. The second pocket 150B has an opening 152B that faces the second transverse edge 128. The end 192B of the second ground stake 190B is inserted into the second pocket 150B through the opening 152B. Along the fabric panel 110, the opening 152B faces towards the second transverse edge 128.

The first and second pockets 150A, 150B can be configured utilize the ground stakes 190A, 190B such that the panel 110 hangs taunt when mounted on the ground stakes 190A, 190B via the pockets 150A, 150B. For example, the pockets 150A, 150B are disposed at different corners of the panel 110 along the same edge 126 with openings 152A, 152B facing away from said edge 126.

The third pocket 150C is configured to receive a third ground stake 190C. For example, the third pocket 150C is configured to receive an end 192C of the third ground stake 190C. The third pocket 150C has an opening 152C that faces the second transverse edge 128. The end 192C of the third ground stake 190C is inserted into the third pocket 150C through the opening 152C. Along the fabric panel 110, the opening 152B faces towards the second transverse edge 128.

In the illustrated embodiment, the pockets 150A, 150B, 150C are affixed to the fabric panel 110 along the first transverse edge 126 (e.g., closer to the first transverse edge 126 than to the second transverse edge 128, at or less than 25% of the height of the fabric panel 110 from first transverse edge 126) and face the second transverse edge 128. In another embodiment, the pockets 150A, 150B, 150C may be affixed to the fabric panel 110 along the second transverse edge 128 (e.g., closer to the second transverse edge 128 than to the first transverse edge 126, at or less than 25% of the height of the fabric panel 110 from the second transverse edge 128) and face the first transverse edge 126.

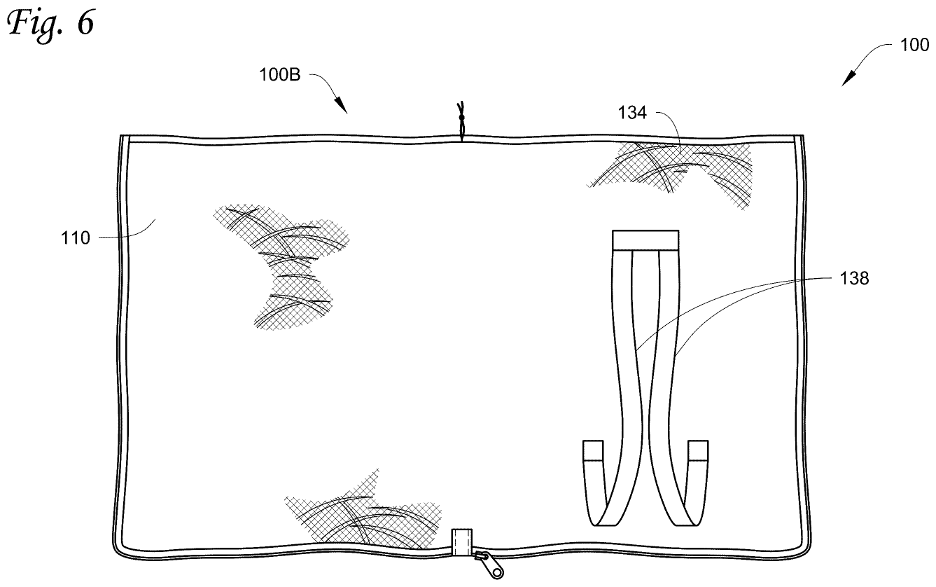

FIG. 6 shows a front perspective view of the hunting blind 100B. The fabric panel 110 includes an outer surface 134 and an inner surface 136 (e.g., shown in FIG. 2) opposite to the outer surface 134. The outer surface 134 forms the exterior of the decoy bag 100A and the inner surface 136 forms the interior of the decoy bag 100A. At least one of the outer surface 134 and the inner surface 136 has a camouflage pattern. In an embodiment, the camouflage pattern is provided on the entirety of the outer surface 134 or the inner surface 136 (e.g., on the entire outer surface 134 in FIG. 6). As similarly discussed above with respect to illustration of the mesh of the fabric panel 110, the figures (e.g., FIGS. 1, 3, and 6) only explicitly show the camouflage pattern for the illustrated mesh portions for illustrative/clarity purposes. As shown in FIGS. 5 and 6, the camouflage pattern can be provided on a surface 134, 136 opposite to the pockets 150A, 150B, 150C. In the illustrated embodiment, the pockets 150A, 150B, 150B are provided on the inner surface 136 and the outer surface 134 has the camouflage pattern. In an embodiment, the pockets 150A, 150B, 150C may be provided on the outer surface 134 and the inner surface 136 can have a camouflage pattern. In another embodiment, the pockets 150A, 150B, 150C and the camouflage pattern may be provided on the same surface 134, 136. As shown in FIG. 2, the surface 134, 136 with the pockets 150A, 150B, 150C may not have a camouflage pattern. The convertible bag 100 can also include one or more straps 138 (e.g., shoulder straps) on the outer surface 134 for carrying the decoy bag 100A.

As shown in FIGS. 2 and 5, convertible bag 100 can also include first loops 156A, 156B, 156C and second loops 158A, 158B for holding the fabric panel 110 to the ground stakes 190A, 190B, 190C. The loops 156A-156C, 158A, 158B are each affixed to the fabric panel 110 (e.g., to the same surface 134, 136 as the pockets 150A, 150B, 150C). The loops 156A-156C, 158A, 158B are used along with the pockets 150A, 150B, 150C to mount the fabric panel 110 onto the ground stakes 190A, 190B, 190C.

The first pocket 150A is used with a respective first loop 156A and a respective second loop 158A to hold the fabric panel 110 on the first stake 190A. Similar to the first pocket 150A, the first loop 156A and the second loop 158B are affixed to the fabric panel 110 along the first side edge 122 of the fabric panel 110. The first loop 156A is also located along an opposite side edge 122, 124 of the fabric panel 110 to the first pocket 150A. For example, in FIG. 2, the first pocket 150A is located along the first transverse edge 126 and the first loop 156A is located along the second transverse edge 128. The second loop 158A is located along the first side edge 122 between the first pocket 150A and the first loop 156A (e.g., disposed between the first pocket 150B and the second loop 156B along the width w). Each loop 156A, 158A is aligned with the first pocket 150A along the first side edge 122 (e.g., in the direction of the width w, aligned with the opening 152A of the first pocket 150A in the direction of the width w). As shown in FIG. 5, the first pocket 150A is disposed on an upper end/portion of the first stake 190A, the first loop 156A encircles a lower end/portion of the first stake 190A, and the second loop 158A encircles a middle portion of the first stake 190A.

The second pocket 150B is used with a respective first loop 156B and a respective second loop 158B to hold the fabric panel 110 on the second stake 190B. Similar to the second pocket 150B, the first loop 156B and the second loop 158B are affixed to the fabric panel 110 along the second side edge 124 of the fabric panel 110. The first loop 156B is also located along an opposite end edge 122, 124 of the fabric panel 110 to the second pocket 150B. For example, in FIG. 2, the second pocket 150B is located along the first transverse edge 126 and the first loop 156B is located along the second transverse edge 128. The second loop 156B is located along the first side edge 122 between the second pocket 150B and the first loop 156B (e.g., disposed between the second pocket 150B and the second loop 156B along the width w). Each loop 156B, 158B is aligned with the second pocket 150B along the second side edge 124 (e.g., in the direction of the width w, aligned with the opening 152B of the second pocket 150B in the direction of the width w). As shown in FIG. 5, the second pocket 150B is disposed on an upper end/portion of the second stake 190B, the first loop 156B encircles a lower end/portion of the second stake 190B, and the second loop 156B encircles a middle portion of the second stake 190B. As shown in FIG. 2, the first pocket 150A, the second pocket 150B, the first loop 156A, and the first loop 156B can each be disposed at a different corner of the fabric panel 110.

The third pocket 150C is used with a respective first loop 156C to hold the fabric panel 110 on the third stake 190C. The first loop 156C is also located along an opposite transverse edge 122, 124 of the fabric panel 110 to the second pocket 150B. For example, in FIG. 2, the second pocket 150B is located along the first transverse edge 126 and the first loop 156B is located along the second transverse edge 128. The first loop 156C is affixed to the fabric panel 110 between the first loop 156A for the first pocket 150A and the first loop 156B for the second pocket 150B (e.g., along the length L). The loop 156C is aligned with the third pocket 150B along the width w of the fabric panel 110 (e.g., aligned with the opening 152C of the third pocket 150C in the direction of the width w). As shown in FIG. 5, the third pocket 150C is disposed on an upper end/portion of the third stake 190B and the first loop 156C encircles a lower end/portion of the third stake 190C. In an embodiment, the convertible bag 100 may include a second loop used with the third pocket 150C and first loop 156C (e.g., similar to the second loops 158A, 158B).

In an embodiment, a longer/deeper pocket 150A, 150B, 150C may be used instead of one or more of loops. In one example, the first pocket 150A may have a depth/length that extends to at or about midway of the first side edge 122 instead of having the second loop 158A (e.g., extend at or about half of the width w). For example, the first pocket 150A may have a depth/length that extends more than half of the width w of the first side edge 122 instead of having the second loop 158A. In another example, the first pocket 150A may extend past 75% of the width of the first side edge 122 instead of having the first loop 156A. For example, the first pocket 150A may have a depth/length that extends to at or about the second transverse edge 128 instead of having the first loop 156A.

As shown in FIG. 2, the pockets 150A, 150B, 150C can be formed using a respective portion of the material of the fabric panel 110. For example, the back portion of the first pocket 150A is formed from the material of the fabric panel 110 in the illustrated embodiment. In another embodiment, the pockets 150A, 150B, 150C may be have a pocket shape separate from the fabric panel 110 that is affixed to the fabric panel 110.

FIG. 7 is rear view of convertible bag 100 as the hunting blind 100B being employed by a user 199 (e.g., a hunter). The end 194 of each stake 190A, 190B, 190B is inserted into the ground G and the fabric panel 110 is mounted to the stakes 190A, 190B, 190B. The fabric panel 110 is mounted at or about vertical to the ground G to obscure the hunter (e.g., vertical to the ground G, within 20 degrees of vertical to the ground G). For example, the pockets 150A, 150B, 150C are configured to hold the stakes 190A, 190B, 190C such that the fabric panel 110 extends at or about vertical to the ground G (e.g., the outer surface and/or inner surface of the fabric panel 110 extends at or about vertical to the ground G). For example, the placement of the pockets 150A, 150B, 150C over the ends 192A, 192B, 192C of the ground stakes 190A, 190B, 190C hangs the fabric panel 110 from the ground stakes 190A, 190B, 190C at or about vertical.

The first transverse edge 126 can be an upper edge of the hunting blind 100B that the hunter views over to spot fowl. The second transverse edge can be a lower edge of the hunting blind 100B that is disposed at or near the ground G (e.g., in contact with the ground G).

In FIG. 7, the hunting blind 100B provides camouflage to the user 199 in a direction out of the page. The side edges 122, 124 form the left and right edges of the hunting blind 100B, and the first and second transverse edges 126, 128 form the top and bottom edges of the hunting blind 100B. As shown in FIG. 7, the third pocket 150C can be used for the hunting blind 100B to be anchored in a concave shape. The concave shape can help provide improved coverage of the user 199 (e.g., in a greater range of directions, etc.). In another embodiment, the hunting blind 100B may be anchored in a different shape (e.g., a linear shape).

As shown in FIG. 5, the convertible bag 100 can include three ground stakes 190A, 190B, 190C and three pockets 150A, 150B, 150C for receiving ground stakes 190A, 190B, 190C. It should be appreciated that the convertible bag 100 in other embodiments may be configured to use a different number of ground stakes/pockets than three. In an embodiment, the convertible bag 100 can have two or more of the pockets 150A, 150B, 150C. For example, the convertible bag 100 may have two pockets 150A, 150B and utilize two ground stakes 190A, 190B. For example, the convertible bag 100 may have four or more pockets 150A, 150B, 150C and utilize four or more ground stakes 190A, 190B, 190C. In such an embodiment, the additional pockets (e.g., pocket four, pocket five, etc.) can be affixed to the fabric panel 110 between the first pocket 150A and the second pocket 150B along the length L of the fabric panel 110.

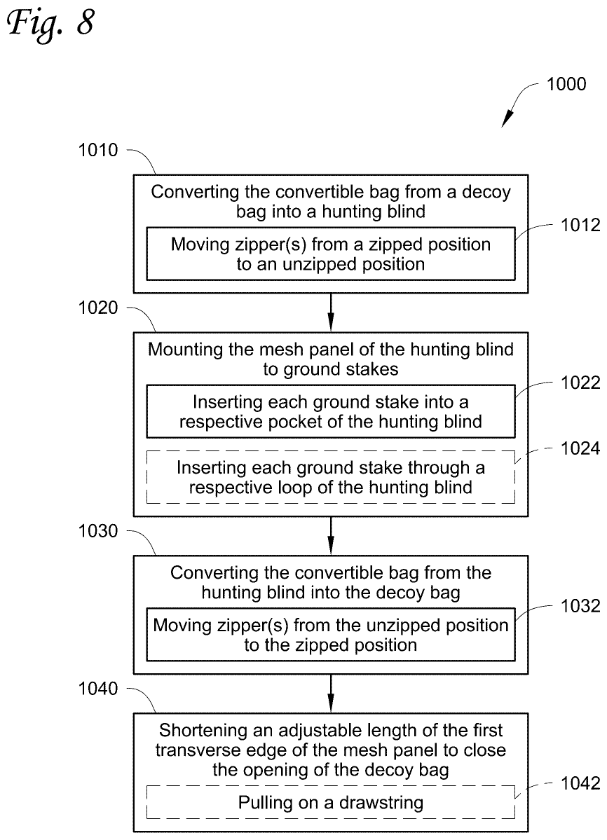

FIG. 8 shows a block flow diagram of a method 1000 of operating a convertible bag. For example, the method 1000 may be used for operate the convertible bag 100 in FIGS. 1-7. The convertible bag includes a fabric panel (e.g., fabric panel 110), a first pocket affixed to the fabric panel (e.g., first pocket 150A), a second pocket (e.g., second pocket 150B) affixed to the fabric panel, and at least one zipper (e.g., zipper 140). The fabric panel includes a first side edge (e.g., first side edge 122), a second side edge (e.g., second side edge 124), a first transverse edge (e.g., first transverse edge 126) and a second transverse edge (e.g., second transverse edge 128). The method 1000 starts at 1010.

At 1010, the convertible bag is converted from a decoy bag (e.g., decoy bag 100A) into a hunting blind 100B. The converting from a decoy bag into the hunting blind 100B includes moving the zipper(s) of the convertible bag from a zipped position to an unzipped position 1012. In the zipped position, the first side edge is coupled to the second side edge by the zipper(s) and a first portion (e.g., first portion 130) of the second transverse edge is coupled to a second portion (e.g., second portion 132) of the second transverse edge by the zipper(s). The moving of zipper(s) from the zipped position to the unzipped position at 1012 includes uncoupling the first side edge from the second side edge and uncoupling the first portion of the first transverse edge from the second portion of the second transverse edge. For example, unzipping of the zipper(s) at 1012 forms/converts the convertible bag into the hunting blind shape/configuration. The method 1000 then proceeds to 1020.

At 1020, the fabric panel of the hunting blind is mounted to ground stakes (e.g., first ground stakes 190A, second ground stake 190B, third ground stake 190C). The mounting of the fabric panel at 1020 includes inserting each ground stake into a respective pocket of the hunting blind at 1022. For example, the inserting of the ground stakes at 1022 includes inserting a first ground stake (e.g., end 192A of the first ground stake 190A) into the first pocket and inserting a second ground stake (e.g., end 192B of the second ground stake 190B) in the second pocket. The mounting of the fabric panel at 1022 can also include inserting each ground stake through a respective loop of the hunting blind 1024. For example, inserting the ground stakes through a respective loop of the hunting blind at 1024 can include inserting the first ground stake through one or more respective loops (e.g., first loop 156A, second loop 158A) affixed to the fabric panel. For example, inserting the ground stakes through a respective loop of the hunting blind at 1024 can include inserting the second ground stake through one or more respective loops (e.g., first loop 156B, second loop 158B) affixed to the fabric panel.

In an embodiment, the method 1000 can include inserting the stakes into the ground (e.g., ground G) such that the hunting blind is anchored/secured to the ground at or about vertical to the ground (e.g., the fabric panel extending at or about perpendicular to the ground). In one example, the ground stakes are already inserted into the ground (e.g., ground G) such that the mounting at 1020 results in the hunting blind being anchored at or about perpendicular to the ground (e.g., hunting blind extending at or about vertical relative to the horizontal ground). In another example, the ground stakes may be inserted into the ground after the mounting at 1020 to result in hunting blind being anchored at or about vertical to the ground. The method 1000 then proceeds to 1030.

At 1030, the convertible bag is converted from the hunting blind into the decoy bag. The converting at 1030 includes moving the zipper(s) from the unzipped position to the zipped positon 1032. The zipping of the zipper(s) at 1032 couples the first side edge is coupled to the second side edge by the zipper(s) and couples the first portion of the first transverse edge to the second portion of the second transverse edge. For example, a first zipper portion (e.g., first zipper portion 144A) of the zipper(s) couples the first side edge to the second side edge. For example, a second zipper portion (e.g., second zipper portion 144B) of the zipper(s) couples the first portion of the first transverse edge from the second portion of the second transverse edge. For example, zipping of the zipper(s) at 1012 forms/converts the convertible bag into the decoy bag shape/configuration. The method 1000 then proceeds to 1040.

At 1040, an adjustable length (e.g., length L) of the first transverse edge of the fabric panel is shortened to close the opening (e.g., opening 104) of the decoy bag. In an embodiment, the convertible bag may include a drawstring (e.g., a drawstring 160) for adjusting the length of the first transverse edge. The closing of the decoy bag at 1040 can include pulling on the drawstring at 1042. The pulling of the drawstring at 1042 shortens the length of the first transverse edge which closes the decoy bag.

It should be appreciated that the order of the converting between the hunting blind and the decoy bag at 1010 and 1030 can occur in a different order in the method 1000 (e.g., 1030 may occurring prior to the converting 1010 in an embodiment of the method 1000). It should be appreciated that the method 1000 in an embodiment may be modified to include features as shown and/or described for the convertible bag in FIGS. 1-7.

The terminology used herein is intended to describe particular embodiments and is not intended to be limiting. The terms “a,” “an,” and “the” include the plural forms as well, unless clearly indicated otherwise. Unless specified otherwise, “one or more” is interpreted in the disjunctive (e.g., one or more of A and B includes A alone, B alone, or A and B in combination). The terms “comprises” and/or “comprising,” when used in this Specification, specify the presence of the stated features, integers, steps, operations, elements, and/or components, but do not preclude the presence or addition of one or more other features, integers, steps, operations, elements, and/or components. In an embodiment, “couples” and “affixed” as described herein can refer to being “directly coupled” and “directly affixed”, respectively.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

What is claimed is:

1. A convertible bag, comprising:
a fabric panel including:
a first side edge and a second side edge opposite the first side edge, and
a first transverse edge and a second transverse edge each extending between the first side edge and the second side edge,
a first pocket affixed to the fabric panel and configured to receive a first ground stake;
a second pocket affixed to the fabric panel and configured to receive a second ground stake; and
one or more zippers for the fabric panel, the one or more zippers having an unzipped position and a zipped position,
wherein in the zipped position, a first zipper portion of the one or more zippers couples the first side edge to the second side edge to form a sidewall, and a second zipper portion of the one or more zippers couples a first portion of the second transverse edge to a second portion of the second transverse edge to form a closed end, such that the fabric panel forms a decoy bag, and
wherein in the unzipped position, the fabric panel forms a hunting blind.

2. The convertible bag of claim 1, wherein in the unzipped position, the first side edge is uncoupled from the second side edge and the first portion of the second transverse edge is uncoupled from the second portion of the second transverse edge.

3. The convertible bag of claim 1, wherein
in the zipped position, the first transverse edge forms an opening of the decoy bag, the first transverse edge having an adjustable length for adjusting the opening between an open position and a closed position.

4. The convertible bag of claim 3, further comprising:
a drawstring extending through a channel in the fabric panel between the first side edge and the second side edge, the drawstring configured to adjust the adjustable length of the first transverse edge.

5. The convertible bag of claim 1, wherein the fabric panel includes an inner surface and an outer surface opposite the inner surface, the first pocket and the second pocket are affixed to one of the inner surface or the outer surface of the fabric panel, and a different one of the inner surface or the outer surface of the fabric panel has a camouflage pattern.

6. The convertible bag of claim 5, wherein in the zipped position, the outer surface forms an exterior surface of the decoy bag.

7. The convertible bag of claim 6, wherein the first pocket and the second pocket are each affixed to the inner surface of the fabric panel.

8. The convertible bag of claim 1, wherein one of:
each of the first pocket and the second pocket is affixed on the fabric panel along the first transverse edge and has a respective opening that faces towards the second transverse edge along the fabric panel, or
each of the first pocket and the second pocket is affixed on the fabric panel along the second transverse edge and has the respective opening that faces towards the first transverse edge along the fabric panel.

9. The convertible bag of claim 1, further comprising:
a first loop affixed to the fabric panel, the first loop configured to be aligned with the first pocket along the first side edge for holding the first ground stake; and
a second loop affixed to the fabric panel, the second loop configured to be aligned with the second pocket along the second side edge for holding the second ground stake.

10. The convertible bag of claim 9, wherein
the first pocket has an opening for the first ground stake that faces towards the first loop along the fabric panel, and
the second pocket has an opening for the second ground stake that faces towards the second loop along the fabric panel.

11. The convertible bag of claim 1, further comprising:
a third pocket affixed to the fabric panel between the first pocket and the second pocket along the first transverse edge, the third pocket configured to receive a third ground stake.

12. The convertible bag of claim 1, wherein the fabric panel has a width of at least 2 feet and a length of at least 3 feet.

13. A method of operating a convertible bag, the convertible bag including a fabric panel, a first pocket affixed to the fabric panel for receiving a first ground stake, a second pocket affixed to the fabric panel for receiving a second ground stake, and one or more zippers, the fabric panel including a first side edge and a second side edge opposite the first side edge, and a first transverse edge and a second transverse edge each extending between the first side edge and the second side edge, the method comprising:
converting the convertible bag from a decoy bag into a hunting blind, which includes moving the one or more zippers from a zipped position to an unzipped positon, wherein
in the zipped position, a first zipper portion of the one or more zippers couples the first side edge to the second side edge to form a sidewall, and a second zipper portion of the one or more zippers couples a first portion of the second transverse edge to a second portion of the second transverse edge to form a closed end, such that the fabric panel forms the decoy bag, and
moving the one or more zippers from the zipped position to the unzipped positon includes uncoupling the first side edge from the second side edge and uncoupling the first portion of the second transverse edge to a second portion of the second transverse edge, such that the fabric panel forms the hunting blind.

14. The method of claim 13, further comprising:
mounting the fabric panel to a first ground stake and a second ground stake, which includes inserting an end of a first ground stake in the first pocket and inserting an end of a second ground stake in the second pocket, such that the fabric panel is secured by the first and second ground stakes to extend at or about perpendicular to the ground.

15. The method of claim 14, wherein the coupling of the fabric panel to the first ground stake and the second ground stake includes:
inserting the first ground stake through a first loop affixed to the fabric panel, a middle portion of the first ground stake disposed in the first loop, and
inserting the second ground stake through a second loop affixed to the fabric panel, a middle portion of the second ground stake disposed in the second loop.

16. The method of claim 13, further comprising:
converting the convertible bag from the hunting blind into the decoy bag, which includes moving the one or more zippers from the unzipped position to the zipped position, moving the one or more zippers from the unzipped position to the zipped position including:
coupling, with the first zipper portion, the first side edge to the second side edge to form the sidewall, and
coupling, with the second zipper portion, a first portion of the second transverse edge to a second portion of the second transverse edge to form the closed end.

17. The method of claim 13, wherein in the zipped position, the first transverse edge forms an opening of the decoy bag, and the method further comprises:
closing the opening of the decoy bag by shortening an adjustable length of the first transverse edge.

18. The method of claim 17, wherein
the convertible bag includes a drawstring extending through a channel in the fabric panel between the first side edge and the second side edge, and
the shortening of the adjustable length of the first transverse edge includes pulling on the drawstring to cause the adjustable length of the first transverse edge to shorten and close the opening.
